(19) United States
(12) Patent Application Publication
(10) Pub. No.: US 2016/0224327 A1
(43) Pub. Date: Aug. 4, 2016

(54) Linking a Program with a Software Library

(71) Applicant: Lenovo Enterprise Solutions (Singapore) Pte. Ltd., Singapore (SG)

(72) Inventors: Frank W. Angelotti, Rochester, MN (US); Eric E. Blouin, Ardmore, PA (US); Gerald G. Stanquist, Salt Point, NY (US); Dermot Weldon, Dublin (IE)

(73) Assignee: Lenovo Enterprise Solutions (Singapore) Pte. Ltd., Singapore (SG)

(21) Appl. No.: 14/611,680

(22) Filed: Feb. 2, 2015

(51) Int. Cl. G06F 9/445; G06F 9/44

(52) U.S. Cl. CPC G06F 8/54; G06F 8/71

(57) ABSTRACT

Embodiments relate to importing files or a file set from a library as an import set and dynamically extracting and compiling the import set at run-time. The library stores one or more files and any incremental changes to the files. Versioning information is read from the import set. Import of the files from the library is limited to dependencies that are needed to support program execution. The import set transforms the program, and in one embodiment modifies execution of the program. At run-time, non-compiled program code of the import set is compiled with the program to dynamically execute the program.

### BACKGROUND

The present invention relates to importing one or more files from a shared library in support of execution of an application. More specifically, the invention relates to associating an import set from the library, and dynamically extracting the import set at application run-time.

A software library is a suite of data and programming code that is used to develop software programs and applications. It is designed to assist both the programming and the programming language compiler in building and executing programs. The library generally consists of pre-written code, classes, procedures, scripts, configuration data, and more. The use of the library may eliminate the need to write complex functions. All of the functions within the library can be called or used within the program.

The library is used in the software industry to manage collaboration between software developers and to manage software versioning. However, the library is known to retain multiple versions, also referred to herein as copies, of the same file. Maintaining duplicate copies of the same file requires additional storage space and also may complicate execution of the program calling the files from the library.

### SUMMARY

The invention includes a method, computer program product, and system for versioning changes in files in the library, and dynamically importing a set of files to support execution of a program.

A method, computer program product, and system are provided for transforming program execution. For each executable program version, an import set of files is stored in the library. Stored files include storage of a change to a file as an incremental file. At least one program to be executed is transformed. Versioning information for the stored import set of files in support of the program is ascertained. The import set includes at least one file and at least one stored incremental file. The import set is associated with the program, causing transformation of the program by linking non-compiled code of the import set from the library to create an import commit from the library. At run-time of the program, the import set is dynamically extracted and compiled to support execution of the transformed program.

Other features and advantages of this invention will become apparent from the following detailed description of the presently preferred embodiment(s) of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated.

FIG. 1 depicts a flow chart illustrating a process for creating incremental files and storing the incremental files in the library.

FIG. 2 depicts a block diagram illustrating a sample library with respect to a software file and stored incremental files.

FIG. 3 depicts a flow chart illustrating a process for dynamically loading links within non-compiled code utilizing the library.

FIG. 4 depicts a block diagram illustrating an example of a plurality of programs and a plurality of supporting incremental files stored in the library.

FIG. 5 depicts a block diagram illustrating the library, and more specifically tools that support the functionality of the library while supporting efficiency of storage and management.

FIG. 6 depicts a cloud computing node according to an embodiment of the present invention.

FIG. 7 depicts a cloud computing environment according to an embodiment of the present invention.

FIG. 8 depicts abstraction model layers according to an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

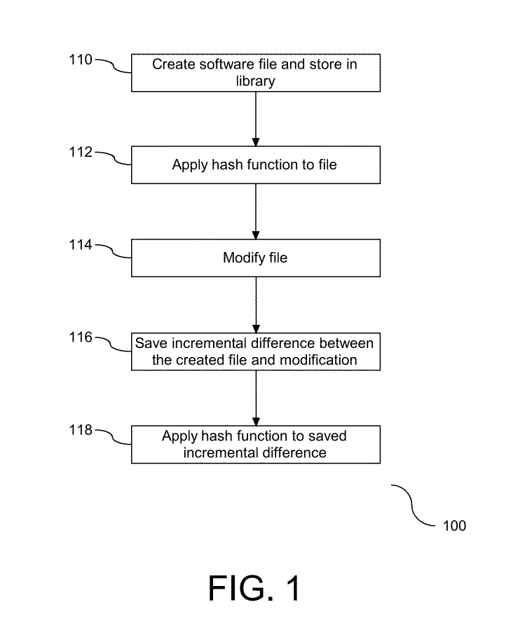

The embodiments disclosed herein pertain to sharing software programs across multiple software projects without risking impact to the projects case by changes required for a single project, and without storing multiple copies of the same named files. With reference to FIG. 1, a flow chart (100) is provided illustrating a process for creating incremental files, hereinafter referred to as increments, and storing the increments in a shared software library, hereinafter referred to as the library. A software file, hereinafter referred to as the file, is created and stored in the library (110). The stored file has a specific version. For example, an initial copy of the file may be referred to as a first version, and a first set of changes to the file may change some functionality in the associated program code which when saved may be referred to as a second version. It is understood that the file may evolve over time, with changes to the file reflecting improvements or added functionality. In one embodiment, a hash function may be applied (112) to the file created at step (110). As the file is modified (114), an incremental difference between the file created at step (110) and the modification at step (114) is saved as an increment (116), and a hash function may be applied to the saved incremental difference (118). Each time an incremental difference to the software file is created, the incremental difference between the current file version and the prior file or incremental version is saved as an increment and stored in the library. In one embodiment, an incremental version change may reflects about 10% of the file, providing a saving of 90% per version of the file in a system that stores a full copy of each version. Accordingly, as changes are made to the file, it is the incremental differences that are saved and stored, thereby reducing storage capacity requirements associated with duplicate file copies.

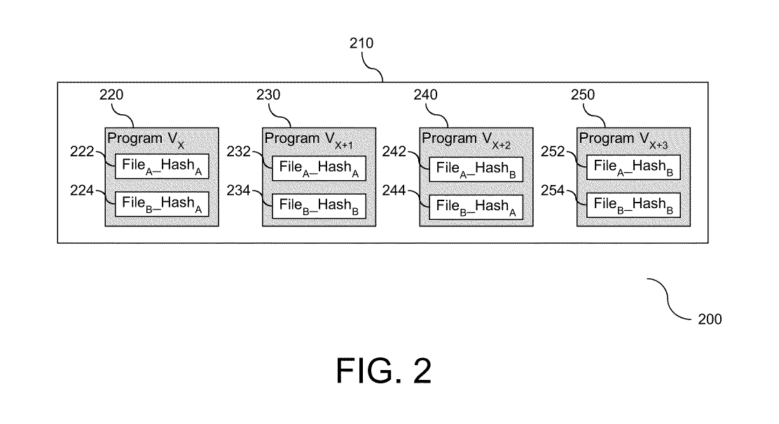

Each file and any associated increment are stored in the library. Referring to FIG. 2, a block diagram (200) is provided illustrating a sample library (210) with respect to a file and stored increment of the file. The library guarantees delivery of all executables and all dependencies stored in the library. The file has to exist in the library system before a version may be selected. Each program has a version, and each version has an import set of files, hereinafter referred to as an import set. In one embodiment, the import set to support program execution may include one or more files and/or associated increments. In the example shown herein, the library (210) stores a plurality of program versions, with each version having an import set. More specifically, the import set identifies the increment(s) of the file or files that support the version. In this example, four versions of the program are shown and described, although this quantity is not considered limiting. A counting variable X identifies the program version. The first version, V_{X}, of the program (220) is shown being comprised of two separate files, file_{A} (222) and file_{B} (224). In one embodiment, a hash is created and stored for each file, wherein the hash is a code that matches a specific file version. With respect to the first version of the program, a first hash, hash_{A}, of each of the supporting files, file_{A} and file_{B}, is identified. In one embodiment, there may be different versions of a supporting file for a program version, and each version has a unique hash to identify the file version. Accordingly, each program version is supported by one or more files, and each of the files may be comprised of one or more versions with each version identified with an associated hash, e.g. unique identifier.

The second version (230), V_{X+1}, of the program is shown being comprised of two separate files, file_{A} (232) and file_{B} (234). The first hash, hash_{A}, of file_{A} is supported in the second version of the program, and a second hash, hash_{B}, of file_{B} is supported in the second version of the program. A third version (240), V_{X+2}, and a fourth version (250), V_{X+3}, of the program are also shown in the library. The third version (240), V_{X+2}, of the program is shown comprised of two separate files, file_{A} (242) and file_{B} (244). More specifically, a second hash, hash_{B}, of file_{A} is supported in the third version of the program, and the first hash, hash_{A} of file_{B} is supported in the third version of the program. The fourth version (250), V_{X+3}, of the program is shown comprised of two separate files, file_{A} (252) and file_{B} (254). More specifically, the second hash, hash_{B}, of file_{A} is supported in the fourth version of the program, and the second hash, hash_{B} of file_{B} is supported in the second version of the program.

In the examples shown herein, there are four program versions, with each version comprised of different files and increment combinations. Each program is comprised of at least one file, and in one embodiment may be comprised of two or more files. The quantity of supporting files shown herein is for illustrative purposes only and should not be considered limiting. Furthermore, each file may have one or more stored versions. Each file version has a unique identifier, which in one embodiment is in the form of a hash code to match a specific version. An import set for a program associates one or more files and increments with each program version. In one embodiment, multiple executable programs may use or import the same file, either at the same or at different version levels.

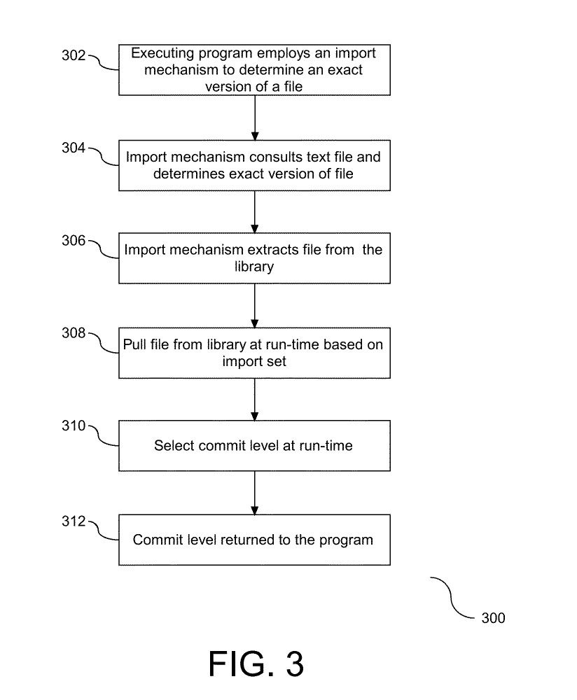

Referring to FIG. 3, a flow chart (300) is provided illustrating a process for an executing program to dynamically select and import one or more files of non-compiled code in the library. The aspect of associating an executable with one or more increments from an import set transforms the program, and in one embodiment, transforms the functionality of the program. As shown, an executing program employs an import mechanism to determine an exact version of a file (302). There are different ways for the import mechanism to determine the version, including but not limited to, polling an external system, such as a database. Another mechanism, as shown and described herein is for the library to employ a text file, such as a look-up table, to store an association between an executing or executable program and one or more supporting files and/or increments. For a given program, the supporting file and increments are known. Following the request at step (302), the import mechanism consults the text file, e.g. look-up table, to determine an exact version of a file (304).

Once the version is determined by the import mechanism at (304), the import mechanism proceeds to extract the determined file from the library (306). The library stores all current and past versions of files in a manner where only the increments between versions are saved. The executable programs themselves are stored and delivered from the library system. The import mechanism sorts out the various versions of the same file per an executable file, which allows multiple executables to use or import the same file but at different version levels. Because all files are stored in the library, the library guarantees delivery of all executables and all dependent files stored in the library. More specifically, the library makes it impossible to deliver less than all the files and dependencies because it is an atomic operation. In one embodiment, an atomic operation is one in which a processor can simultaneously read a location and write it in the same bus operation. Accordingly, either all executables and increments arrive together or none arrive.

The import set extracted at step (306) is not compiled with the program until run-time. In one embodiment, the returned import set is referred to as non-compiled code. In one embodiment, the import file set includes the files, and more specifically, the increments of the file that supports the given program. Accordingly, an import set is associated with at least one program, and when compiled effectively transforms the functionality of the program.

With the import set returned, the current program may be executed. At run time, the file, and in one embodiment one or more increments, from the library are pulled based on the returned import set (308). In one embodiment, the import mechanism may be employed to lookup the file and/or increments, and a requestor pulls the identified file and/or increments from the library. As shown in FIG. 2, each version of the file has an associated identifier, hash code. Following step (308) and using the associated file identifier for each file supporting the program, a commit level is selected at run-time (310) and returned to the program (312). Based on the selected commit level, the transformed program is executed, which includes compiling non-compiled code of the import set of the transformed program at run-time. In one embodiment, the commit level is the version of each file in support of the program version being executed. Similarly, in one embodiment, there may be multiple commit levels of the same file name. Accordingly, by using the library, an associated set of imports, e.g. an import set, is dynamically extracted from a database and compiled within the program at run-time, with the set of imports describing dependencies for importing files and unique versioning information required for the import.

As shown and described herein, the library stores incremental changes and when called returns the whole file with selected increments. More specifically, the selected increments reflect and identify changes made to any file and does not replicate portions of the file that are already stored in the library. The manner in which the library is used at run-time brings both storage efficiency and management efficiency. The incremental manner of storing changes allows the freedom to change an executable for different needs. Accordingly, efficiency is provided to both the library and the manner of storing data, together with manipulating the library to support dynamic import of the file changes.

The organization of the library, and specifically the manner in which an incremental change to a file is identified and stored as a file version, provides storage efficiency and access efficiency. The organization guarantees that all files are present, including a program version and an import set associated with the program version.

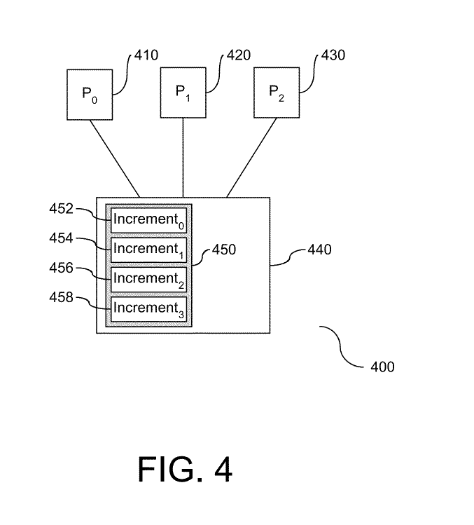

The following is an example of the import mechanism for use with the library and the stored increment(s). As shown in FIG. 4, a block diagram (400) is provided illustrating a plurality of programs and a plurality of supporting increments stored in the library. In this example, three programs are employed program₀ (410), program₁ (420), and program₂ (430). Each of these programs is in communication with library (440). More specifically, each of the programs uses an increment (450) as a dependency. A change to the increment (450), which in one embodiment includes selection or assignment of a different increment to the program, will affect all three programs (410), (420), and (430) that list the dependency. Furthermore, as shown in this example, there are four versions of the dependency shown herein as increments (450), including increment₀ (452), increment₁ (454), increment₂ (456), and increment₃ (458). In this example, the most recent version of the dependency (450), increment₃ (458), causes one of the programs, program₀ (410), to crash. Reverting back to the prior file version, increment₂ (456), resolves the error and enables program₀ (410) to function. Through the import mechanism shown and described in FIG. 3, program₀ (410) references the prior file version, increment₂ (456), while program₁ (420) and program₂ (430) reference the most recent file version, increment₃ (458). Accordingly, without creating a new library with special behaviors to resubmitting a prior file version and promoting it within the library, the import mechanism enables different programs to reference and import different supporting file versions in the library.

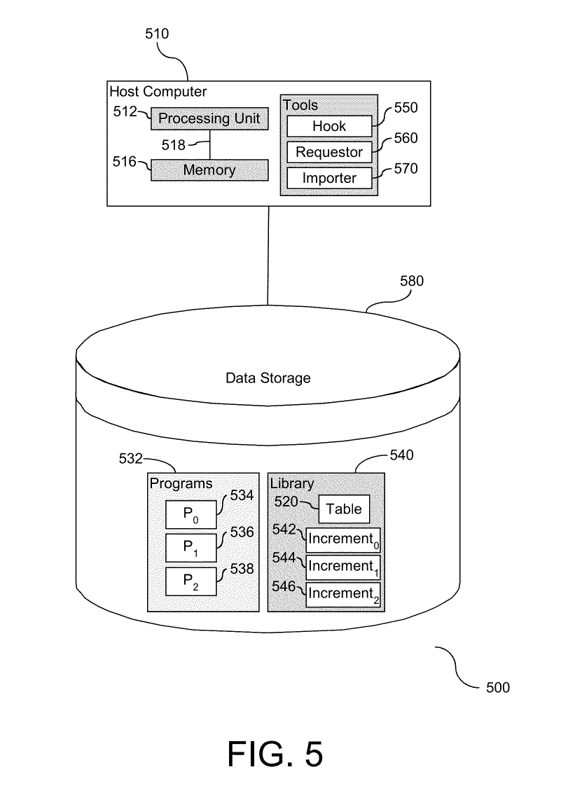

Referring to FIG. 5, a block diagram (500) is provided illustrating the library, and more specifically tools that support transformation of the executable program based on the functionality of the library. As shown, a host computer (510), also referred to herein as a server, is provided with a processing unit (512) in communication with memory (516) across a bus (518). Data storage (580) is provided in communication with the host computer (510). Data storage (580) is shown as a local connection to the host computer. In one embodiment, the data storage (580) may be remote from the host computer (510), or the data storage (570) may be a part of a storage subsystem. Regardless of the location or configuration of the data storage or storage system, library (540) is embedded in the storage. Executable programs may be provided location to the host computer or located in data storage. In the example shown herein, executable programs (532) are shown local to the data storage (580). More specifically, in the example shown herein, a plurality of executable programs (534), (536), and (538) are shown, although the quantity should not be considered limiting. In addition, the data storage is shown with the library (540) with stored file versions referred to herein as increments. In the example shown herein, the library (540) is shown with three increments (542), (544), and (546), although this quantity should not be considered limiting. As described in FIGS. 3 and 4, an import mechanism is employed to dynamically associate an increment with a program. The increments (542)-(546) are stored in the library (540) and delivered from the library (540) to support program execution. As files are modified and saved, a new increment is stored in the library (540) and reflects changes from a prior saved increment and does not include the file in its entirety. Accordingly, only incremental differences between increments are saved in the library (540).

Tools may be provided local to or in communication with the host computer (510). In the example shown herein, the tools are local to the host (510), although in one embodiment they may be embedded in a system in communication with the host (510) via a network connection. The tools include, but are not limited to, a hook (550), an importer (570), and a requestor (560). The importer (570) functions as an import mechanism that allows a program to identify an increment from the library (540), including any past or present version of an import file to be selected from a library's system database. More specifically, the importer (570) functions to allow the executing program to decide on the exact version of the file required or desired to support the executing program. In one embodiment, the importer (570) may conduct a poll within the library and looks up the file version for the executable and any dependencies. Similarly, in another embodiment, the importer (570) may conduct a poll to an external system to determine the appropriate increment(s) to support the executing program. Similarly, in one embodiment, a look-up table (520) is provided in communication with the library (540) to organize increments and the association of increments to a program version, and the importer (570) utilizes the look-up table to ascertain versioning information including the appropriate file version and any dependencies. Accordingly, the hook (550) together with the support of the importer (570) effectively transforms the executable program based upon the increments being imported from the library (540).

Given a file and file version(s), the hook (550) can extract the identified file(s) from the library (540). More specifically, the hook (550) sorts various versions of the same file per an executable file, which allows multiple executables to use or import the same file but at different increments, and links non-compiled code of an import set of files from the library (540). The linking created by the hook (550) creates an import commit from the library (540). Based on the configuration of the library (540) with the increments, the library (540) guarantees delivery of all executables and all increments, also referred to herein as dependencies. The requestor (560) functions to communicate with the hook (550) for delivery of the executable and increments from the library (540) in an atomic operation, and more specifically, the requestor dynamically extracts and compiles code of the import set from the library at run-time. Due to the characteristics associated with an atomic operation, either all of the deliverables are returned together to the requestor (560), or none of the deliverables are returned. The file has to first exist in the library (540) before an increment of the file can be selected. Accordingly, all deliveries are self-consistent.

The server described above in FIG. 5 has been labeled with one or more tools, in the form of an importer, a hook, and a requestor, to facilitate and support manufacturing decisions. The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

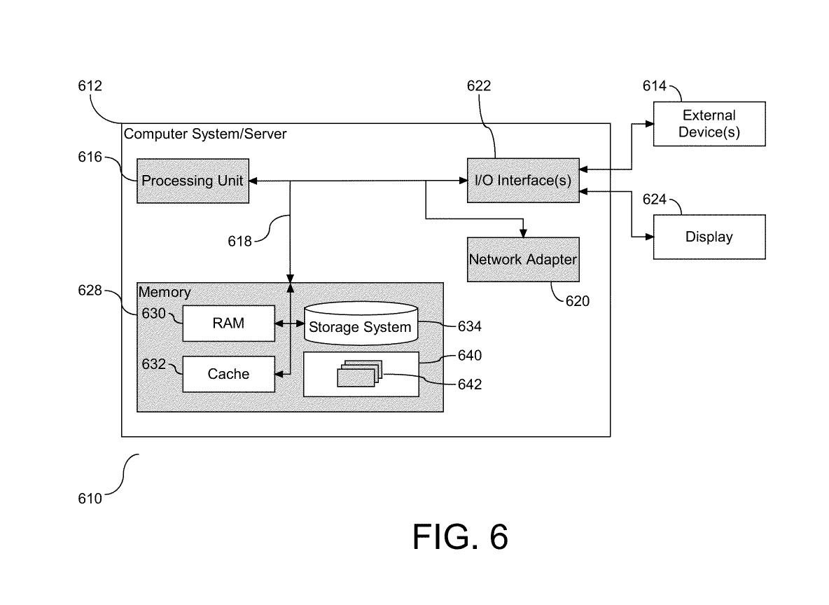

The library and the tools that support the functionality associated with importing an executable and relevant dependencies may be implemented in a shared pool of configurable resources, i.e. a cloud based system. A cloud computing environment is service oriented with a focus on statelessness, low coupling, modularity, and semantic interoperability. At the heart of cloud computing is an infrastructure comprising a network of interconnected nodes. Referring now to FIG. 6, a schematic of an example of a cloud computing node is shown. Cloud computing node (610) is only one example of a suitable cloud computing node and is not intended to suggest any limitation as to the scope of use or functionality of embodiments of the invention described herein. Regardless, cloud computing node (610) is capable of being implemented and/or performing any of the functionality set forth hereinabove. In cloud computing node (610) there is a computer system/server (612), which is operational with numerous other general purpose or special purpose computing system environments or configurations. Examples of well-known computing systems, environments, and/or configurations that may be suitable for use with computer system/server (612) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server (612) may be described in the general context of computer system-executable instructions, such as program modules, being executed by a computer system. Generally, program modules may include routines, programs, objects, components, logic, data structures, and so on that perform particular tasks or implement particular abstract data types. Computer system/server (612) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server (612) in cloud computing node (610) is shown in the form of a general-purpose computing device. The components of computer system/server (612) may include, but are not limited to, one or more processors or processing units (616), a system memory (628), and a bus (618) that couples various system components including system memory (628) to processor (616). Bus (618) represents one or more of any of several types of bus structures, including a memory bus or memory controller, a peripheral bus, an accelerated graphics port, and a processor or local bus using any of a variety of bus architectures. By way of example, and not limitation, such architectures include an Industry Standard Architecture (ISA) bus, a Micro Channel Architecture (MCA) bus, an Enhanced ISA (EISA) bus, Video Electronics Standards Association (VESA) local bus, and a Peripheral Component Interconnects (PCI) bus. A computer system/server (612) typically includes a variety of computer system readable media. Such media may be any available media that is accessible by a computer system/server (612), and it includes both volatile and non-volatile media, and removable and non-removable media.

System memory (628) can include computer system readable media in the form of volatile memory, such as random access memory (RAM) (630) and/or cache memory (632). Computer system/server (612) may further include other removable/non-removable, volatile/non-volatile computer system storage media. By way of example only, storage system (634) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus (618) by one or more data media interfaces. As will be further depicted and described below, memory (628) may include at least one program product having a set (e.g., at least one) of program modules that are configured to carry out the functions of embodiments of the invention.

Program/utility (640), having a set (at least one) of program modules (642), may be stored in memory (628) by way of example, and not limitation, as well as an operating system, one or more application programs, other program modules, and program data. Each of the operating systems, one or more application programs, other program modules, and program data or some combination thereof, may include an implementation of a networking environment. Program modules (642) generally carry out the functions and/or methodologies of embodiments of the invention as described herein.

Computer system/server (612) may also communicate with one or more external devices (614), such as a keyboard, a pointing device, a display (624), etc.; one or more devices that enable a user to interact with computer system/server (612); and/or any devices (e.g., network card, modem, etc.) that enable computer system/server (612) to communicate with one or more other computing devices. Such communication can occur via Input/Output (I/O) interfaces (622). Still yet, computer system/server (612) can communicate with one or more networks such as a local area network (LAN), a general wide area network (WAN), and/or a public network (e.g., the Internet) via network adapter (620). As depicted, network adapter (620) communicates with the other components of computer system/server (612) via bus (618). It should be understood that although not shown, other hardware and/or software components could be used in conjunction with computer system/server (612). Examples, include, but are not limited to: microcode, device drivers, redundant processing units, external disk drive arrays, RAID systems, tape drives, and data archival storage systems, etc.

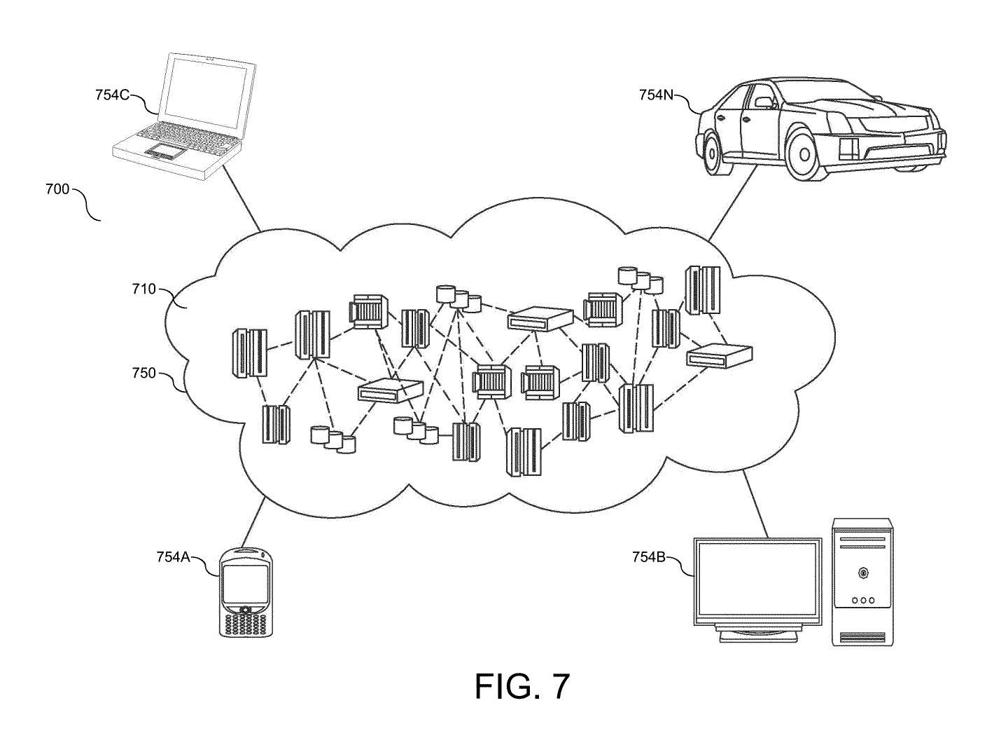

Referring now to FIG. 7, illustrative cloud computing environment (750) is depicted. As shown, cloud computing environment (750) comprises one or more cloud computing nodes (710) with which local computing devices used by cloud consumers, such as, for example, personal digital assistant (PDA) or cellular telephone (754A), desktop computer (754B), laptop computer (754C), and/or automobile computer system (754N) may communicate. Nodes (710) may communicate with one another. They may be grouped (not shown) physically or virtually, in one or more networks, such as Private, Community, Public, or Hybrid clouds as described hereinabove, or a combination thereof. This allows cloud computing environment (750) to offer infrastructure, platforms and/or software as services for which a cloud consumer does not need to maintain resources on a local computing device. It is understood that the types of computing devices (754A)-(754N) shown in FIG. 7 are intended to be illustrative only and that computing nodes (710) and cloud computing environment (750) can communicate with any type of computerized device over any type of network and/or network addressable connection (e.g., using a web browser).

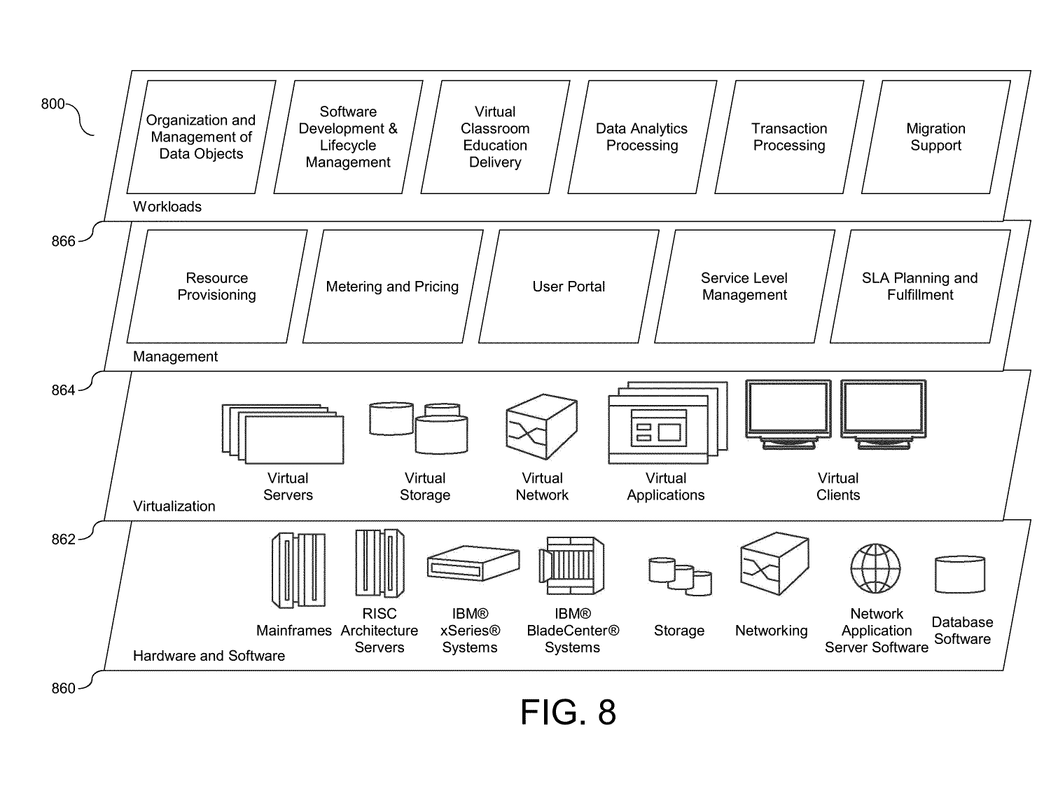

Referring now to FIG. 8, a set of functional abstraction layers provided by cloud computing environment (850) is shown. It should be understood in advance that the components, layers, and functions shown in FIG. 8 are intended to be illustrative only and embodiments of the invention are not limited thereto. As depicted, the following layers and corresponding functions are provided: hardware and software layer (860), virtualization layer (862), management layer (864), and workload layer (866). The hardware and software layer (860) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software (IBM, zSeries, pSeries, xSeries, BladeCenter, WebSphere, and DB2 are trademarks of International Business Machines Corporation registered in many jurisdictions worldwide).

Virtualization layer (862) provides an abstraction layer from which the following examples of virtual entities may be provided: virtual servers, virtual storage, virtual networks, including virtual private networks, virtual applications and operating systems, and virtual clients.

In one example, management layer (864) may provide the following functions: resource provisioning, metering and pricing, user portal, service level management, and SLA planning and fulfillment. The functions are described below. Resource provisioning provides dynamic procurement of computing resources and other resources that are utilized to perform tasks within the cloud computing environment, including extracting an executable program and relevant executable dependencies from a library in the shared pool of resources. Metering and pricing provides cost tracking as resources that are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer (766) provides examples of functionality for which the cloud computing environment may be utilized. An example of workloads and functions which may be provided from this layer includes, but is not limited to, organization and management of the library within the cloud computing environment. In the shared pool of configurable computer resources described herein, hereinafter referred to as a cloud computing environment, files stored in the library may be shared among users within multiple data centers, also referred to herein as data sites. A series of mechanisms are provided within the shared pool to allow multiple executables to use and import the same file, but at different version levels. The organization of the library system guarantees delivery of all executable and all dependencies stored in the library system in the shared pool of resources. The executable and associated dependencies are referred to as deliveries, and are self-consistent with no missing files. The computer storage system provided within the shared pool of resources contains the library, including all executables and all associated dependencies. It should be understood that the library may be located on one data storage unit or across multiple data storage units in the shared pool. Similarly, the tools that support calling the executable and the associated dependencies, including the hook (550) and the requestor (560) may be located on the same host computer in the shared pool, or they may be located on separate host computers. Regardless of the location of the tools, the functionality of the tools and the library support storage of the incremental changes of the file dependencies and delivery of the executable and dependencies from the library (540) in an atomic operation.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the functions/acts specified in the flowcharts and/or block diagrams block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowcharts and/or block diagrams block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. The implementation of a library, and more specifically, the storage structure of a file and any increments, together with the manner in which they are organized into an import set and dynamically delivered to a requesting program provides both storage and management efficiency. Increments of a file are stored and assigned to support specified programs. A commit level is selected by the hook at run-time so that the requestor may dynamically pull the correct version(s), including the correct increment(s), from the library. Accordingly, the optimization of the file versions within the library enables and supports dynamic assessment and delivery for import to an associated requestor to support execution of the program.

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

1. A method for executing a program by a host computer comprising:
transforming, through the host computer, at least one program to be executed, comprising:
selecting an import set from a shared library of base files and one or more incremental files, each incremental file representing a change relative to any of the files;
determining versioning information for the selected import set from the library, the selected import set referencing at least one base file and any corresponding incremental files; and
creating an import commit, including linking non-compiled code of the selected import set; and
dynamically extracting the import commit from the library at run-time, including all file version dependencies needed to support the executing program, wherein the extraction is an atomic operation.

2. The method of claim 1, further comprising limiting storage of files in the library to the incremental file as a difference between file versions.

3. The method of claim 2, further comprising creating an identifier for each incremental file, and associating each created identifier with a single increment.

4. The method of claim 1, further comprising storing an association between each executable program and the stored import set.

5. The method of claim 1, wherein each executable program is a program version, and further comprising associating one stored import set with the program version.

6. The method of claim 5, wherein the stored import set selected from the library includes any past or present file and one or more associated incremental files.

7. A computer program product for executing a program by a host computer, the computer program product comprising a computer readable storage medium having program code embodied therewith, the program code executable by a processing unit to:
transform, through the host computer, at least one program to be executed, comprising:
selecting an import set from a shared library of base files and one or more incremental files, each incremental file representing a change relative to any of the files;
determining versioning information for the selected import set from the library, the selected import set referencing at least one based file and any corresponding incremental files; and
creating an import commit, including linking non-compiled code of the selected import set; and
dynamically extract the import set from the library at run-time, including all file version dependencies needed to support the executing program, wherein the extraction is an atomic operation.

8. The computer program product of claim 7, further comprising program code to limit storage of files in the library to the incremental file as a difference between file versions.

9. The computer program product of claim 8, further comprising program code to create an identifier for each incremental file, and associate each created identifier with a single incremental file.

10. The computer program product of claim 7, further comprising program code to store an association between each executable program and the stored import set.

11. The computer program product of claim 7, wherein each executable program is a program version, and further comprising program code to associate one stored import set with the program version.

12. The computer program product of claim 11, wherein the stored import set selected from the library includes any past or present file and one or more incremental files.

13. A system comprising:
a hardware processing unit in communication with memory;
data storage in communication with the processing unit, the data storage including a shared library;
tools in communication with an executable program, the tools configured to support program execution, the tools comprising:
a hook to transform, through a host computer, at least one program to be executed, the hook to:
select an import set from the library a base file and one or more incremental files, each incremental file representing a change relative to any of the files;
employ an importer, the importer to determine versioning information for the selected import set; and
create an import commit, including linking non-compiled code of the selected import set; and
a requestor to dynamically extract the import commit from the library at run-time, including all file version dependencies to support execution of the program, wherein the extraction is an atomic operation.

14. The system of claim 13, further comprising the shared library to limit storage of file to an incremental difference between incremental files.

15. The system of claim 14, further comprising the hook to create an identifier for each increment file, including the hook to associate each identifier with a single increment file.

16. The system of claim 13, further comprising a data structure to store an association between each executable program and stored import files.

17. The system of claim 13, wherein each executable program is a program version, and further comprising the hook to associate one stored import set of files with the program version.

18. The system of claim 17, wherein the stored import set of files selected from the library includes past and present file versions and incremental files.
